(19) United States
(12) Patent Application Publication
(10) Pub. No.: US 2022/0041068 A1
(43) Pub. Date: Feb. 10, 2022

(54) VEHICLE CONTROLLER FOR AVOIDING COLLISION AND METHOD THEREOF

(71) Applicants: HYUNDAI MOTOR COMPANY, Seoul (KR); KIA CORPORATION, Seoul (KR)

(72) Inventors: Jae Il PARK, Seoul (KR); Sang Ho LEE, Seoul (KR); Seung Ki KIM, Suwon-si (KR); Sung Wook HWANG, Seoul (KR)

(21) Appl. No.: 17/313,314

(22) Filed: May 6, 2021

(30) Foreign Application Priority Data
Aug. 4, 2020 (KR) 10-2020-0097469

(51) Int. Cl. B60L 15/20; G08G 1/16; B60K 28/02; B60K 31/00

(52) U.S. Cl. CPC B60L 15/2009; G08G 1/166; B60K 28/02; B60K 31/0008; B60L 2240/24; B60L 2250/00; B60L 2240/461; B60L 2240/18; B60L 2240/22; B60L 2240/465

(57) ABSTRACT

A vehicle controller for avoiding a collision of a vehicle and a method thereof are provided. The vehicle controller includes a drive motor that supplies electric power for a behavior of a vehicle, sensors that obtain information outside the vehicle and information inside the vehicle, and a controller that estimates, when detecting evasive steering of a driver in a collision situation based on the information outside the vehicle and the information inside the vehicle, a front wheel slip angle and a rear wheel slip angle, and controls the drive motor based on the front wheel slip angle and the rear wheel slip angle.

### CROSS-REFERENCE TO RELATED APPLICATION

This application claims the benefit of priority to Korean Patent Application No. 10-2020-0097469, filed in the Korean Intellectual Property Office on Aug. 4, 2020, the entire contents of which are incorporated herein by reference.

### TECHNICAL FIELD

The present disclosure relates to a vehicle controller for avoiding a collision of a vehicle and a method thereof.

### BACKGROUND

When a driver performs evasive steering in a collision situation, an electrification vehicle, such as a hybrid electric vehicle (HEV) or an electric vehicle (EV), controls a drive motor depending on a gear stage and a brake opening degree or an accelerator opening degree of the driver irrespective of the collision situation.

The information included in this Background section is only for enhancement of understanding of the general background of the present disclosure and may not be taken as an acknowledgement or any form of suggestion that this information forms the prior art already known to a person skilled in the art.

### SUMMARY

The present disclosure has been made to solve the above-mentioned problems occurring in the prior art while advantages achieved by the prior art are maintained intact.

An aspect of the present disclosure provides a vehicle controller for controlling a drive motor to support collision avoidance, when a driver steers a vehicle to avoid a collision in a situation where a collision risk is detected, and a method thereof.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a vehicle controller may include a drive motor that supplies electric power for a behavior of a vehicle, sensors that obtain information outside the vehicle and information inside the vehicle, and a controller that estimates, when detecting evasive steering of a driver in a collision situation based on the information outside the vehicle and the information inside the vehicle, a front wheel slip angle and a rear wheel slip angle, and controls the drive motor based on the estimated front wheel slip angle and the estimated rear wheel slip angle.

The sensors may obtain the information outside the vehicle using at least one of a radio detecting and ranging (RADAR) or a camera.

The sensors may obtain the information inside the vehicle using at least one of a wheel speed sensor, a lateral acceleration sensor, a yaw rate sensor, a steering angle sensor, or a driver steering torque sensor.

The controller may calculate a required amount of acceleration or a required amount of deceleration based on the front wheel slip angle, the rear wheel slip angle, and a vehicle speed.

The controller may adjust the required amount of acceleration or the required amount of deceleration depending on whether a collision risk remains based on the information outside the vehicle.

The controller may set a motor brake control gain and a motor drive control gain in a variable manner based on the vehicle speed and whether the collision risk remains.

The controller may calculate a required amount of driving using the rear wheel slip angle and the motor drive control gain.

The controller may calculate a required amount of braking using the front wheel slip angle and the motor brake control gain.

The controller may control braking using the drive motor, when the front wheel slip angle is greater than the rear wheel slip angle.

The controller may control driving using the drive motor, when the rear wheel slip angle is greater than the front wheel slip angle.

According to an aspect of the present disclosure, a vehicle control method may include obtaining information outside the vehicle and information inside the vehicle using sensors mounted into a vehicle, detecting evasive steering of a driver in a collision situation based on the information outside the vehicle and the information inside the vehicle, estimating a front wheel slip angle and a rear wheel slip angle based on the information outside the vehicle and the information inside the vehicle, and controlling a drive motor based on the front wheel slip angle and the rear wheel slip angle.

The obtaining of the information outside the vehicle and the information inside the vehicle may include obtaining the information outside the vehicle using at least one of a RADAR or a camera and obtaining the information inside the vehicle using at least one of a wheel speed sensor, a lateral acceleration sensor, a yaw rate sensor, a steering angle sensor, or a driver steering torque sensor.

The estimating of the front wheel slip angle and the rear wheel slip angle may include calculating a required amount of acceleration and a required amount of deceleration based on the front wheel slip angle, the rear wheel slip angle, and a vehicle speed.

The estimating of the front wheel slip angle and the rear wheel slip angle may further include adjusting the required amount of acceleration and the required amount of deceleration depending on whether a collision risk remains based on the information outside the vehicle.

The estimating of the front wheel slip angle and the rear wheel slip angle may further include setting a motor brake control gain and a motor drive control gain in a variable manner based on the vehicle speed and whether the collision risk remains.

The estimating of the front wheel slip angle and the rear wheel slip angle may further include calculating a required amount of driving using the rear wheel slip angle and the motor drive control gain.

The estimating of the front wheel slip angle and the rear wheel slip angle may further include calculating a required amount of braking using the front wheel slip angle and the motor brake control gain.

The controlling of the drive motor may include controlling braking using the drive motor, when the front wheel slip angle is greater than the rear wheel slip angle.

The controlling of the drive motor may include controlling driving using the drive motor, when the rear wheel slip angle is greater than the front wheel slip angle.

The vehicle control method may further include controlling to brake using a brake, when the evasive steering of the driver is not detected in the collision situation.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram illustrating a vehicle controller according to embodiments of the present disclosure;

FIG. 2 is a drawing illustrating determination of control of a drive motor according to front and rear wheel side slip angles according to embodiments of the present disclosure;

FIG. 3A is a graph illustrating a vertical tire force applied to a front wheel and a rear wheel according to braking control of a drive motor and driving control of the drive motor according to embodiments of the present disclosure;

FIG. 3B is a drawing illustrating a change in vehicle behavior according to a vertical tire fore according to embodiments of the present disclosure;

FIG. 4 is a flowchart illustrating a vehicle control method according to embodiments of the present disclosure;

FIG. 5A is a graph illustrating a change in yaw rate and side slip angle according to drive motor control according to embodiments of the present disclosure;

FIG. 5B is a graph illustrating a change in lateral distance according to drive motor control according to embodiments of the present disclosure; and

FIG. 6 is a block diagram illustrating a computing system for executing a vehicle control method according to an embodiment of the present disclosure.

### DETAILED DESCRIPTION

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of well-known features or functions will be ruled out in order not to unnecessarily obscure the gist of the present disclosure.

In describing the components of the embodiment according to the present disclosure, terms such as first, second, “A”, “B”, (a), (b), and the like may be used. These terms are merely intended to distinguish one component from another component, and the terms do not limit the nature, sequence or order of the constituent components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

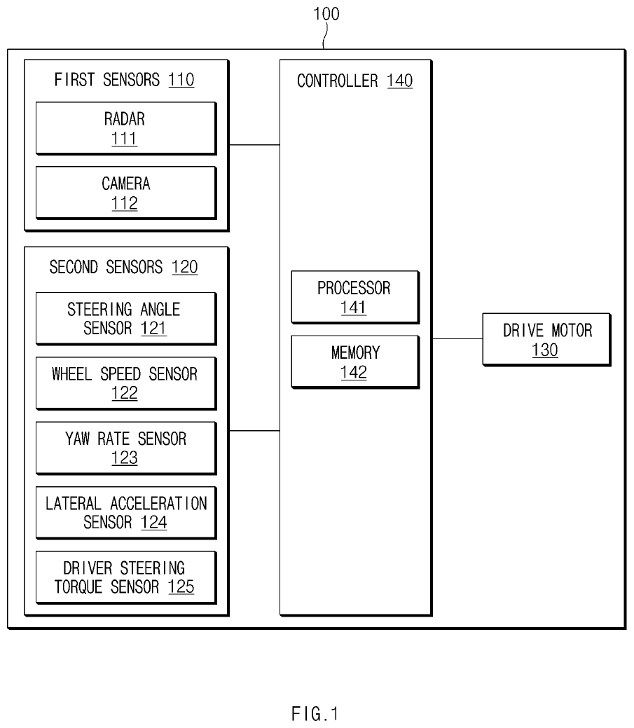

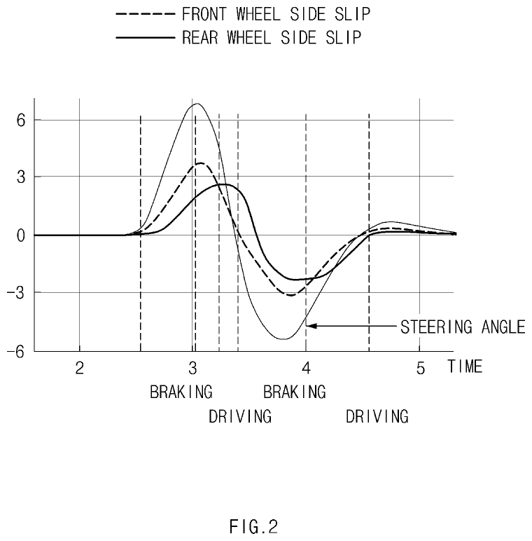

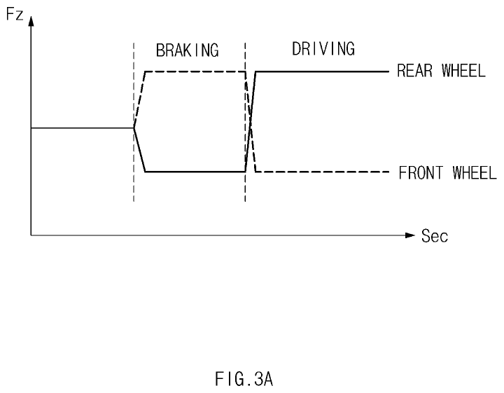

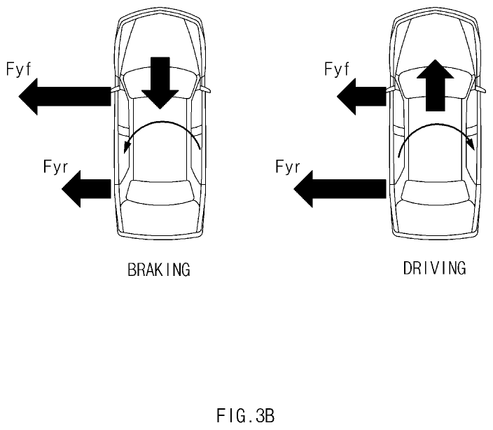

FIG. 1 is a block diagram illustrating a vehicle controller according to embodiments of the present disclosure. FIG. 2 is a drawing illustrating determination of control of a drive motor according to front and rear wheel side slip angles according to embodiments of the present disclosure. FIG. 3A is a graph illustrating a vertical tire force applied to a front wheel and a rear wheel according to braking control of a drive motor and driving control of the drive motor according to embodiments of the present disclosure. FIG. 3B is a drawing illustrating a change in vehicle behavior according to a vertical tire fore according to embodiments of the present disclosure.

A vehicle controller 100 may be mounted into an electrification vehicle. When a driver steers the electrification vehicle to avoid a collision with a surrounding object (e.g., a surrounding vehicle, an obstacle, a pedestrian, and/or the like), the vehicle controller 100 may control a drive motor 130 to suit a collision situation (a situation where there is a collision risk) to avoid the collision. When the vehicle is started, the vehicle controller 100 may initiate its operation together. Such a vehicle controller 100 may include, as shown in FIG. 1, first sensors 110, second sensors 120, a drive motor 130, and a controller 140, which are connected over a vehicle network. The vehicle network may be implemented as a controller area network (CAN), a media oriented systems transport (MOST) network, a local interconnect network (LIN), an Ethernet, an X-by-Wire (Flexray), and/or the like.

The first sensors 110 may obtain information outside the vehicle. The first sensors 110 may include a radio detecting and ranging (RADAR) 111, a camera 112, and/or the like. The RADAR 111 and/or the camera 112 may be installed in a front surface, a rear surface, and/or a side surface of a vehicle body. The RADAR 111 may generate an electromagnetic wave around and may receive an electromagnetic wave reflected from a surrounding object to identify a distance from the surrounding object, a direction of the surrounding object, an altitude of the surrounding object, and the like. The camera 112 may obtain an image around the vehicle, which may be implemented as at least one of image sensors such as a charge coupled device (CCD) image sensor, a complementary metal oxide semi-conductor (CMOS) image sensor, a charge priming device (CPD) image sensor, and/or a charge injection device (CID) image sensor. The camera 112 may include an image processor for performing image processing, such as noise cancellation, color reproduction, file compression, image quality adjustment, and saturation adjustment, for an image obtained by means of the image sensor. The first sensors 110 may further include a sensor for sensing a collision risk. When the collision risk is detected, the first sensors 110 may transmit an emergency signal (e.g., an emergency flag).

The second sensors 120 may obtain information inside the vehicle. The second sensors 120 may include a steering angle sensor 121, a wheel speed sensor 122, a yaw rate sensor 123, a lateral acceleration sensor 124, a driver steering torque sensor 125, and/or the like. The second sensors 120 may obtain information inside the vehicle, such as a vehicle speed, a front wheel steering angle, a rear wheel steering angle, a yaw rate, a lateral acceleration, and/or a driver steering torque, using the sensors 121 to 125 mounted into the vehicle. In the specification, the first sensors 110 and the second sensors 120 may be collectively referred to as sensors.

The drive motor 130 may play a role in generating electric power necessary for driving (behavior) of the vehicle. The drive motor 130 may receive power from a battery (not shown) mounted into the vehicle and may generate electric power to deliver the electric power to vehicle wheels. The battery (not shown) may play a role in supplying power necessary for driving of the vehicle, which may be implemented as a high voltage battery. The drive motor 130 may change a rotational direction and/or a revolution per minute (RPM) under a command of the controller 140. An output torque (a motor torque or motor power) of the drive motor 130 may be adjusted under control of the controller 140.

The drive motor 130 may be used as a generator which generates a back electromotive force when a state of charge (SOC) is insufficient or during regenerative braking and charges the battery (not shown). Furthermore, the drive motor 130 may play a role in cranking an engine (not shown) in the electrification vehicle such as a hybrid electric vehicle (HEV) or a plug-in hybrid electric vehicle (PHEV).

The controller 140 may be an electric control unit (ECU) which controls an operation of the drive motor 130 depending on a situation where the vehicle is traveling. The controller 140 may include a processor 141 and a memory 142. The processor 141 may control the overall operation of the controller 140. The processor 141 may be implemented as at least one of an application specific integrated circuit (ASIC), a digital signal processor (DSP), programmable logic devices (PLD), field programmable gate arrays (FPGAs), a central processing unit (CPU), microcontrollers, or microprocessors. The memory 142 may be a non-transitory storage medium which stores instructions executed by the processor 141. The memory 142 may store a logic (algorithm), which performs a predetermined function, and configuration information. The memory 142 may be implemented as at least one of storage media (recoding media) such as a flash memory, a hard disk, a secure digital (SD) card, a random access memory (RAM), a static RAM (SRAM), a read only memory (ROM), a programmable ROM (PROM), an electrically erasable and programmable ROM (EEPROM), an erasable and programmable ROM (EPROM), and/or a register.

The controller 140 may estimate a vehicle state using sensor information, that is, information outside the vehicle and information inside the vehicle, which is received from the first sensors 110 and the second sensors 120. The controller 140 may process sensor signals output from the first sensors 110 and the second sensors 120 to obtain information necessary to estimate the vehicle state. The controller 140 may analyze the information outside the vehicle and the information inside the vehicle to recognize a surrounding object and may obtain surrounding object information, for example, a type of the recognized surrounding object, a distance between the surrounding object and the vehicle, and a relative speed between the surrounding object and the vehicle. Furthermore, the controller 140 may obtain vehicle driving information, such as a vehicle speed and/or a driving type (e.g., straight driving, a turn, backing-up, and/or the like), from the information outside the vehicle and the information inside the vehicle. The controller 140 may calculate a time to collision (TTC) between the surrounding object and the vehicle based on the surrounding object information and the vehicle driving information. The controller 140 may identify whether there is a collision risk of the vehicle based on the calculated TTC. When there is the collision risk, the controller 140 may determine that the current situation is a collision situation. When there is no collision risk, the controller 140 may determine that the current situation is not the collision situation.

When the current situation is identified (recognized) as the collision situation where there is the collision risk of the vehicle, the controller 140 may determine whether a motion situation of the vehicle meets a condition where steering stability control is initiated and may determine to initiate the steering stability control depending on the determined result. When the vehicle is traveling straight, when the vehicle speed vₓ is within a threshold vehicle speed range (vₘᵢₙ<vₓ<vₘₐₓ), and when the TTC is within a threshold time range (Tₘᵢₙ<TTC<Tₘₐₓ), the controller 140 may determine to initiate the steering stability control. When the vehicle is not traveling straight, when the vehicle speed vₓ is not within the threshold vehicle speed range, and when the TTC is not within the threshold time range, the controller 140 may determine not to initiate the steering stability control. Herein, the threshold vehicle speed range and the threshold time range may be predefined (preset) by a developer to be stored in the memory 142.

When it is determined to initiate the steering stability control, the controller 140 may determine whether the driver steers the vehicle based on a steering torque of the driver, which is measured by the driver steering torque sensor 125. When the steering of the driver is detected, the controller 140 may detect it as evasive steering of the driver.

When the steering of the driver is detected, the controller 140 may calculate a front wheel slip angle (a side slip angle) and a rear wheel slip angle (a side slip angle) using the sensor information. The controller 140 may estimate a front wheel slip angle and a rear wheel slip angle (i.e., the front and rear wheel slip angles) using Equation 1 below and Equation 2 below.

The front wheel slip α_{f} and the rear wheel slip angle αᵣ may be represented as Equation 1 below and Equation 2 below, respectively.

$$\begin{matrix}{α}_{f} = {δ}_{f} - β - \frac{{l}_{f}}{{v}_{x}} γ & [ Equation 1 ] \\ {α}_{r} = {δ}_{r} - β - \frac{{l}_{r}}{{v}_{x}} γ & [ Equation 2 ]\end{matrix}$$

Herein, δ_{f} denotes the front wheel steering angle measured by the steering angle sensor 121, δᵣ denotes the rear wheel steering angle measured by the steering angle sensor 121, l_{f} denotes the distance from the center of gravity point of the vehicle to the front wheel, lᵣ denotes the distance from the center of gravity point of the vehicle to the rear wheel, vₓ denotes the vehicle speed (the wheel speed sensor correction value), γ denotes the yaw rate measured by the yaw rate sensor 123, and β denotes the estimated vehicle body slip angle.

The vehicle body slip angle β may be defined as Equation 3 below.

$$β = \int ( \frac{{A}_{y}}{{v}_{x}} - γ ) dt \qquad [ Equation 3 ]$$

Herein, A_{y} denotes the lateral acceleration estimated by the lateral acceleration sensor 124.

The controller 140 may determine whether drive motor control is on or off based on whether the evasive steering of the driver is detected and the calculated front and rear wheel slip angles. When the evasive steering of the driver is not detected or when the front wheel slip angle and the rear wheel slip angle are identical to each other within an allowable error range, the controller 140 may determine that the drive motor control is off. When the evasive steering of the driver is detected or when the front wheel slip angle is greater than or less than the rear wheel slip angle, the controller 140 may determine that the drive motor control is on. Herein, the front wheel slip angle and the rear wheel slip angle may be used as absolute values (sizes). Referring to FIG. 2, the controller 140 may determine that drive motor braking control is on, when the front wheel slip angle is greater than the rear wheel slip angle, and may determine that drive motor driving control is on, when the rear wheel slip angle is greater than the front wheel slip angle.

When it is determined that the drive motor control is on, the controller 140 may calculate a required amount of acceleration or a required amount of deceleration of the drive motor 130 based on the front and rear wheel slip angles. The controller 140 may calculate a required driving force (a request driving force) or a required braking force (a request braking force) to follow the calculated required amount of acceleration and the calculated required amount of deceleration. The controller 140 may determine an amount of drive motor control based on the calculated required amount of acceleration or the calculated required amount of deceleration. The controller 140 may transmit a control value (e.g., a motor torque) to the drive motor 130 based on the determined amount of drive motor control.

Hereinafter, a description will be given in detail of a method for applying a motor torque to the drive motor 130 in the controller 140.

Referring to FIG. 3A, when braking is controlled using the drive motor 130, a vertical front wheel tire force may increase and a vertical rear wheel tire force may decrease. Furthermore, when driving is controlled using the drive motor 130, a vertical front wheel tire force may decrease and a vertical rear wheel tire force may increase. Because the higher the vertical tire force, the more the lateral force increases, as shown in FIG. 3B, a lateral force of the front wheel may increase upon braking control using the drive motor 130 and a lateral force of the rear wheel may increase upon driving control using the drive motor 130. Thus, the controller 140 may estimate front and rear wheel slip angles and may determine a control mode (e.g., braking control or driving control) of the drive motor 130 based on the estimated front and rear wheel slip angles. In other words, the controller 140 may adjust a motor torque based on the front and rear wheel slip angles.

For example, the controller 140 may calculate a motor torque Tq based on a control torque application algorithm.

Control Torque Application Algorithm

if
| α_{ƒ} | > | αₚ | && | α_{ƒ} | ≥ ε _{ƒ}
Tq = −k₁ | α_{ƒ} |,k₁ > 0
else if
| αᵣ | > | α_{ƒ} | && | αᵣ | ≥ ε ᵣ
Tq = k₂ | αᵣ |,k₂ > 0
else
Tq = 0

Herein, ε_{f} denotes the front wheel threshold slip angle, εᵣ denotes the rear wheel threshold slip angle, l₁ denotes the motor brake control gain, k₂ denotes the motor drive control gain, and Tq denotes the motor torque (− denotes braking and + denotes driving).

When the front wheel slip angle is greater than the rear wheel slip angle and when the front wheel slip angle is greater than or equal to the front wheel threshold slip angle, the controller 140 may calculate the motor torque Tq using the motor brake control gain k₁ and the front wheel slip angle. When the rear wheel slip angle is greater than the front wheel slip angle and when the rear wheel slip angle is greater than or equal to the rear wheel threshold slip angle, the controller 140 may calculate the motor torque Tq using the motor drive control gain k₂ and the rear wheel slip angle. Herein, k₁ and k₂ may vary with a vehicle speed and whether there is a collision risk (whether a collision risk remains).

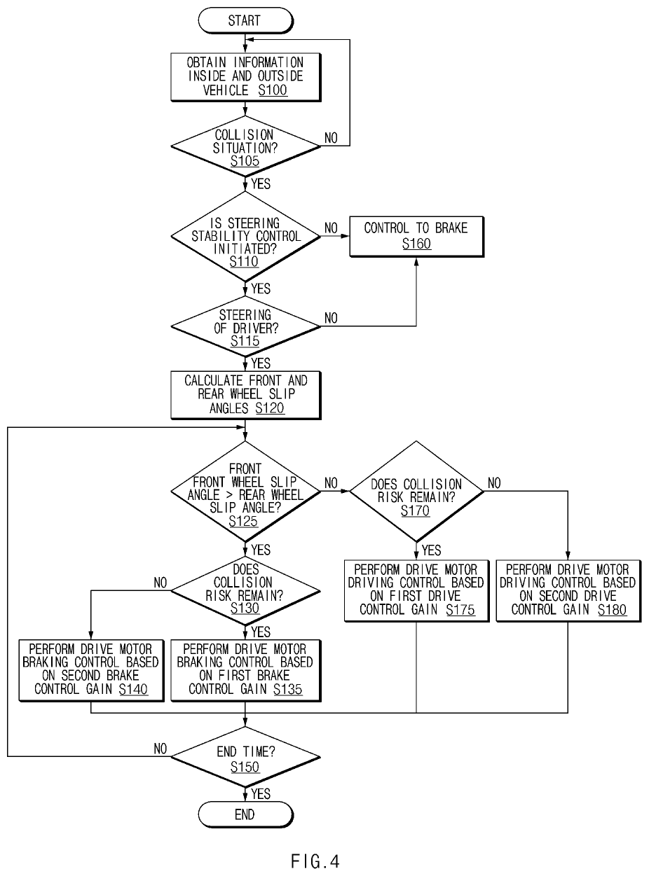

FIG. 4 is a flowchart illustrating a vehicle control method according to embodiments of the present disclosure.

Referring to FIG. 4, in S100, a controller 140 of FIG. 1 may obtain information inside and outside a vehicle by means of sensors mounted into the vehicle when the vehicle is traveling. The controller 140 may obtain the information outside the vehicle by means of first sensors 110 of FIG. 1 and may obtain the information inside the vehicle using second sensors 120 of FIG. 1. Herein, the first sensors 110 may include a RADAR 111, a camera 112, and/or the like, and the second sensors 120 may include a steering angle sensor 121, a wheel speed sensor 122, a yaw rate sensor 123, a lateral acceleration sensor 124, a driver steering torque sensor 125, and/or the like. The controller 140 may recognize an object around the vehicle based on the information outside the vehicle and the information inside the vehicle. For example, the controller 140 may identify a type of an object (a surrounding object) located around the vehicle, a distance between the vehicle and the object, and a relative speed between the object and the vehicle, using a front RADAR, a front-side RADAR, a back-side RADAR, and a front view camera.

In S105, the controller 140 may determine whether the vehicle is in a risk situation (collision situation) capable of colliding with the surrounding object based on the information inside and outside the vehicle. The controller 140 may calculate a time to collision (TTC) between the vehicle and the surrounding object using the information inside and outside the vehicle. The controller 140 may determine whether the current situation is a collision situation, based on the calculated TTC.

When it is determined that the current situation is the collision situation, in S110, the controller 140 may determine whether to initiate steering stability control based on a motion situation of the vehicle. The controller 140 may identify whether the motion situation of the vehicle meets a condition where the steering stability control is initiated and may determine to initiate the steering stability control depending on the identified result. When the vehicle is traveling straight, when the vehicle speed vₓ is within a threshold vehicle speed range (vₘᵢₙ<vₓ<vₘₐₓ), and when the TTC is within a threshold time range (Tₘᵢₙ<TTC<Tₘₐₓ), the controller 140 may determine to initiate the steering stability control. When the vehicle is not traveling straight, when the vehicle speed vₓ is not within the threshold vehicle speed range, and when the TTC is not within the threshold time range, the controller 140 may determine not to initiate the steering stability control.

When it is determined to initiate the steering stability control, in S115, the controller 140 may determine whether steering of a driver is detected. When the steering of the driver is detected, the controller 140 may recognize it as evasive steering of the driver.

When the steering of the driver is detected, in S120, the controller 140 may calculate a front wheel slip angle and a rear wheel slip angle. Upon the evasive steering of the driver, the controller 140 may combine the front wheel slip angle, the rear wheel slip angle, and a vehicle speed to calculate a required amount of acceleration or a required amount of deceleration.

In S125, the controller 140 may compare the front wheel slip angle with the rear wheel slip angle to determine whether the front wheel slip angle is greater than the rear wheel slip angle. The controller 140 may compare the front wheel slip angle with the rear wheel slip angle to determine whether drive motor control is on or off based on the compared result. The controller 140 may determine that drive motor braking control is on, when the front wheel slip angle is greater than the rear wheel slip angle, and may determine that drive motor driving control is on, when the rear wheel slip angle is greater than the front wheel slip angle. Furthermore, when the front wheel slip angle and the rear wheel slip angle are identical to each other within an allowable error range, the controller 140 may determine that the drive motor control is off.

When the front wheel slip angle is greater than the rear wheel slip angle, in S130, the controller 140 may determine whether a collision risk remains based on the information outside the vehicle. When the front wheel slip angle is greater than the rear wheel slip angle, the controller 140 may enable drive motor braking control. The controller 140 may adjust the previously calculated required amount of deceleration depending on whether the collision risk remains. The controller 140 may set a motor brake control gain k₁ in a variable manner depending on whether the collision risk remains and a vehicle speed. The controller 140 may set a first brake control gain to the motor brake control gain, when the collision risk remains, and may set a second brake control gain to the motor brake control gain, when the collision risk does not remain.

When the collision risk remains, in S135, the controller 140 may perform drive motor braking control based on the first brake control gain. The controller 140 may calculate a required amount of braking based on the adjusted required amount of deceleration. The controller 140 may calculate a motor torque using the first brake control gain and the front wheel slip angle. The controller 140 may control the drive motor 130 based on the calculated motor torque (the calculated required amount of braking).

When the collision risk does not remain, in S140, the controller 140 may perform drive motor braking control based on the second brake control gain. The controller 140 may calculate a required amount of braking based on the previously calculated required amount of deceleration. The controller 140 may calculate a motor torque using the second brake control gain and the front wheel slip angle and may control the drive motor 130 based on the calculated motor torque (the calculated required amount of braking).

In S150, the controller 140 may determine whether the state of the vehicle is at a time when the steering stability control is ended. When the collision risk disappears and when the vehicle is stabilized, the controller 140 may determine that the state of the vehicle is at the time when the steering stability control is ended to end the steering stability control.

When it is not determined to initiate the steering stability control in S110 or when the steering of the driver is not detected in S115, in S160, the controller 140 may control to brake using a brake. The controller 140 may perform forward collision-avoidance assist (FCA) control and/or adaptive emergency brake (AEB) control depending on a collision situation.

When the front wheel slip angle is less than the rear wheel slip angle in S125, in S170, the controller 140 may determine whether a collision risk remains. When the rear wheel slip angle is greater than the front wheel slip angle, the controller 140 may enable drive motor driving control. Furthermore, the controller 140 may determine whether the collision risk currently remains based on the information outside the vehicle. When the collision risk remains, the controller 140 may adjust the previously calculated required amount of acceleration. The controller 140 may set a motor drive control gain k₂ in a variable manner depending on whether the collision risk remains and a vehicle speed. The controller 140 may set a first drive control gain to the motor drive control gain, when the collision risk remains, and may set a second drive control gain to the motor drive control gain, when the collision risk does not remain.

When the collision risk remains, in S175, the controller 140 may perform drive motor driving control based on the first drive control gain. The controller 140 may calculate a required amount of driving based on the calculated required amount of acceleration. The controller 140 may calculate a motor torque using the first drive control gain and the rear wheel slip angle. The controller 140 may control an operation of the drive motor 130 based on the calculated motor torque (the calculated required amount of driving).

When the collision risk does not remain in S170, in S180, the controller 140 may perform drive motor driving control based on the second drive control gain. The controller 140 may calculate a required amount of driving based on the previously calculated required amount of acceleration. The controller 140 may calculate a motor torque using the second drive control gain and the rear wheel slip angle. The controller 140 may control an operation of the drive motor 130 based on the calculated motor torque (the calculated required amount of driving).

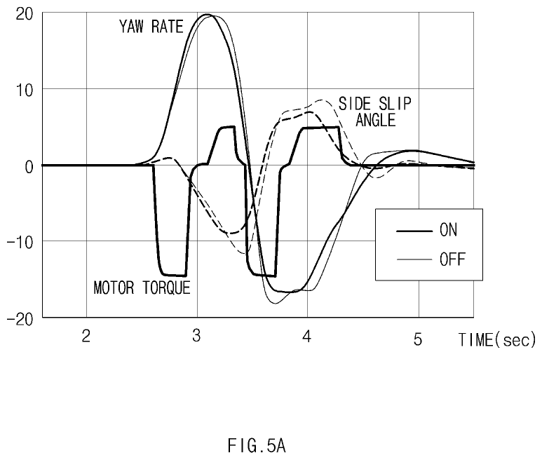

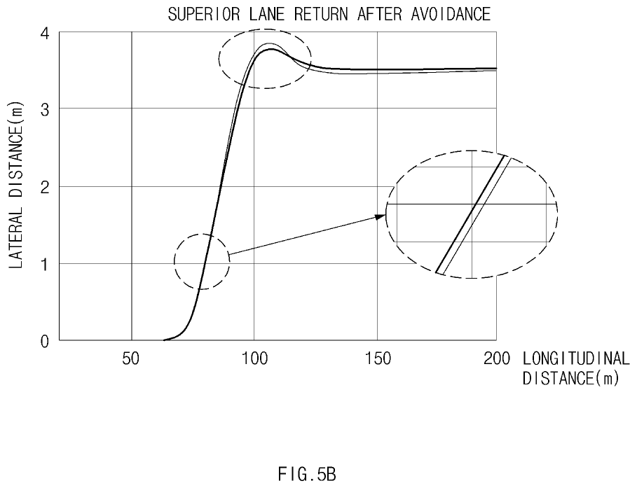

FIG. 5A is a graph illustrating a change in yaw rate and side slip angle according to drive motor control according to embodiments of the present disclosure. FIG. 5B is a graph illustrating a change in lateral distance according to drive motor control according to embodiments of the present disclosure.

It may verified that collision avoidance performance and vehicle stability are more improved when collision avoidance is performed through drive motor control upon evasive steering of the driver in a collision situation than when collision avoidance is performed without drive motor control. Referring to FIG. 5A, as compared with when drive motor control is off, a yaw rate may increase at the beginning of making a turn and a side slip angle may decrease at the beginning of making the turn, and the yaw rate may decrease at the end of making the turn and the side slip angle may decrease at the end of making the turn.

Referring to FIG. 5B and Table 1 below, as the yaw rate increases and the side slip angle decreases at the beginning of making a turn, it may be verified that an avoidance distance increases, that is, collision avoidance performance is improved, upon evasive steering of the driver. Furthermore, because the yaw rate decreases and the side slip angle decreases at the end of making a turn, it may be verified that vehicle stability is improved after collision avoidance.

TABLE 1

| Avoidance of | Avoidance | | |
|---|---|---|---|
| 80 KPH 3.5 m | distance | Yaw rate | Side slip angle |
| Compared | Increase | Increase of 3% | Decrease of 21.8% |
| with when | of 7 cm | (19.16→19.77) | (−11.85→−9.26) |
| control is | | | |
| off | | | |

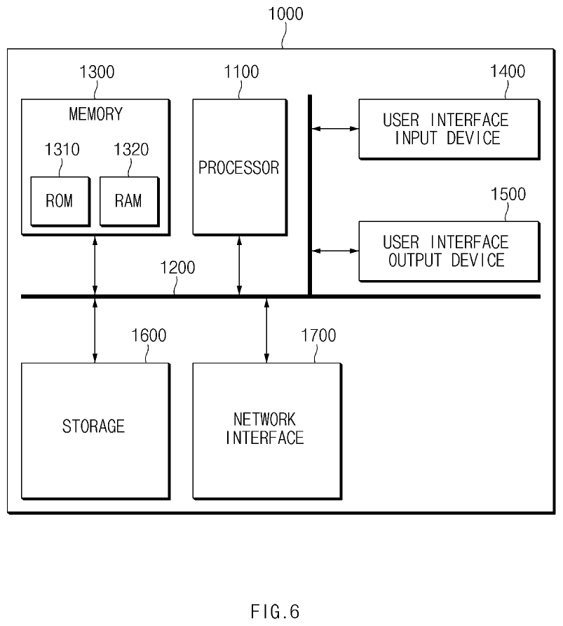

FIG. 6 is a block diagram illustrating a computing system for executing a vehicle control method according to an embodiment of the present disclosure.

Referring to FIG. 6, a computing system 1000 may include at least one processor 1100, a memory 1300, a user interface input device 1400, a user interface output device 1500, storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a read only memory (ROM) 1310 and a random access memory (RAM) 1320.

Thus, the operations of the method or the algorithm described in connection with the embodiments disclosed herein may be embodied directly in hardware or a software module executed by the processor 1100, or in a combination thereof. The software module may reside on a storage medium (that is, the memory and/or the storage) such as a RAM, a flash memory, a ROM, an EPROM, an EEPROM, a register, a hard disk, a removable disk, and a CD-ROM. The exemplary storage medium may be coupled to the processor 1100, and the processor 1100 may read information out of the storage medium and may record information in the storage medium. Alternatively, the storage medium may be integrated with the processor 1100. The processor 1100 and the storage medium may reside in an application specific integrated circuit (ASIC). The ASIC may reside within a user terminal. In another case, the processor 1100 and the storage medium may reside in the user terminal as separate components.

According to embodiments of the present disclosure, when a driver steers a vehicle to avoid a collision in a situation where a collision risk is detected, because the vehicle controller controls a drive motor to support collision avoidance, it may improve collision avoidance performance (increase an avoidance distance) and may avoid the collision to enhance stability of the vehicle.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims. Therefore, the exemplary embodiments of the present disclosure are provided to explain the spirit and scope of the present disclosure, but not to limit them, so that the spirit and scope of the present disclosure is not limited by the embodiments. The scope of the present disclosure should be construed on the basis of the accompanying claims, and all the technical ideas within the scope equivalent to the claims should be included in the scope of the present disclosure.

What is claimed is:

1. A vehicle controller, comprising:
a drive motor configured to supply electric power for a behavior of a vehicle;
sensors configured to obtain information outside the vehicle and information inside the vehicle; and
a controller configured to:
when detecting evasive steering of a driver in a collision situation based on the information outside the vehicle and the information inside the vehicle, estimate a front wheel slip angle and a rear wheel slip angle, and
control the drive motor based on the estimated front wheel slip angle and the estimated rear wheel slip angle.

2. The vehicle controller of claim 1, wherein the sensors obtain the information outside the vehicle using at least one of a Radio Detecting And Ranging (RADAR) or a camera.

3. The vehicle controller of claim 1, wherein the sensors obtain the information inside the vehicle using at least one of a wheel speed sensor, a lateral acceleration sensor, a yaw rate sensor, a steering angle sensor, or a driver steering torque sensor.

4. The vehicle controller of claim 1, wherein the controller calculates a required amount of acceleration or a required amount of deceleration based on the front wheel slip angle, the rear wheel slip angle, and a vehicle speed.

5. The vehicle controller of claim 4, wherein the controller adjusts the required amount of acceleration or the required amount of deceleration depending on whether a collision risk remains based on the information outside the vehicle.

6. The vehicle controller of claim 5, wherein the controller sets a motor brake control gain and a motor drive control gain in a variable manner based on the vehicle speed and whether the collision risk remains.

7. The vehicle controller of claim 6, wherein the controller calculates a required amount of driving using the rear wheel slip angle and the motor drive control gain.

8. The vehicle controller of claim 6, wherein the controller calculates a required amount of braking using the front wheel slip angle and the motor brake control gain.

9. The vehicle controller of claim 1, wherein, when the front wheel slip angle is greater than the rear wheel slip angle, the controller controls braking using the drive motor.

10. The vehicle controller of claim 1, wherein, when the rear wheel slip angle is greater than the front wheel slip angle, the controller controls driving using the drive motor.

11. A vehicle control method, comprising:
obtaining information outside a vehicle and information inside the vehicle using sensors disposed in the vehicle;
detecting evasive steering of a driver in a collision situation based on the information outside the vehicle and the information inside the vehicle;
estimating a front wheel slip angle and a rear wheel slip angle based on the information outside the vehicle and the information inside the vehicle; and
controlling a drive motor based on the front wheel slip angle and the rear wheel slip angle.

12. The vehicle control method of claim 11, wherein the obtaining of the information outside the vehicle and the information inside the vehicle includes:
obtaining the information outside the vehicle using at least one of a Radio Detecting And Ranging (RADAR) or a camera; and
obtaining the information inside the vehicle using at least one of a wheel speed sensor, a lateral acceleration sensor, a yaw rate sensor, a steering angle sensor, or a driver steering torque sensor.

13. The vehicle control method of claim 11, wherein the estimating of the front wheel slip angle and the rear wheel slip angle includes calculating a required amount of acceleration and a required amount of deceleration based on the front wheel slip angle, the rear wheel slip angle, and a vehicle speed.

14. The vehicle control method of claim 13, wherein the estimating of the front wheel slip angle and the rear wheel slip angle further includes adjusting the required amount of acceleration and the required amount of deceleration depending on whether a collision risk remains based on the information outside the vehicle.

15. The vehicle control method of claim 14, wherein the estimating of the front wheel slip angle and the rear wheel slip angle further includes setting a motor brake control gain and a motor drive control gain in a variable manner based on the vehicle speed and whether the collision risk remains.

16. The vehicle control method of claim 15, wherein the estimating of the front wheel slip angle and the rear wheel slip angle further includes calculating a required amount of driving using the rear wheel slip angle and the motor drive control gain.

17. The vehicle control method of claim 15, wherein the estimating of the front wheel slip angle and the rear wheel slip angle further includes calculating a required amount of braking using the front wheel slip angle and the motor brake control gain.

18. The vehicle control method of claim 11, wherein the controlling of the drive motor includes, when the front wheel slip angle is greater than the rear wheel slip angle, controlling braking using the drive motor.

19. The vehicle control method of claim 11, wherein the controlling of the drive motor includes, when the rear wheel slip angle is greater than the front wheel slip angle, controlling driving using the drive motor.

20. The vehicle control method of claim 11, further comprising, when the evasive steering of the driver is not detected in the collision situation, controlling a brake to reduce a vehicle speed or stop the vehicle.
